(19) United States
(12) Patent Application Publication
(10) Pub. No.: US 2026/0312408 A1
(43) Pub. Date: Oct. 8, 2026

(54) METHOD FOR AVOIDING A POWER FAILURE IN AN ELECTRICAL GRID

(71) Applicant: Fronius International GmbH, Pettenbach (AT)

(72) Inventor: Joachim DANMAYR, Pettenbach (AT)

(73) Assignee: Fronius International GmbH, Pettenbach (AT)

(21) Appl. No.: 19/472,138

(22) PCT Filed: Apr. 4, 2024
(86) PCT No.: PCT/EP2024/059259

§ 371 Date: Oct. 3, 2025

(30) Foreign Application Priority Data
Apr. 4, 2023 (EP) 23166512.6

(51) Int. Cl. H02J 3/14; H02J 3/001; H02J 13/12; H02J 105/53

(52) U.S. Cl. CPC H02J 3/14; H02J 3/00125; H02J 13/12; H02J 2105/53

(57) ABSTRACT

Method and apparatus for avoiding a power failure in at least one electrical subgrid (TN) which, for the purpose of supplying power to electrical loads, v, of the subgrid (TN), is connected to a transmission grid (ÜN). The electrical loads, v, of the subgrid (TN) are divided into a number, N, of different groups (G1, G2, . . . Gi . . . GN) with different priorities (p1, p2, . . . pi . . . pN). The method which can be carried out on a controller of the subgrid (TN) comprises the steps of: calculating (S1) an overall required total reduction current amount, Ired-gesamt, by which the total electrical current amount, lakt-gesamt, currently consumed by all loads, v, of the subgrid (TN) should be reduced in order to avoid a detected overload in the subgrid (TN); determining (S2) a group target current amount (IsollGi) for each divided group (Gi) of loads, v, on the basis of the overall required total reduction current amount, Ired-gesamt, and a current amount that can be saved by the particular group (Gi); calculating (S3) target currents (Isoll-v) for the electrical loads, v, in the divided groups (G1, G2, . . . Gi . . . GN) of the subgrid (TN) on the basis of the determined group target current amount (IsollGi), and computationally reducing (S4) the current amount currently consumed by the loads, v, in the particular group (Gi) until the group target current amount (IsolIGi) determined for the particular group (Gi) is achieved.

The invention relates to a method and device for preventing a power failure in an electrical grid, in particular in a subgrid connected to a transmission grid.

In an electrical distribution grid, the electrical energy made available to consumers must, at all times, be equal to the electrical energy generated or supplied. An imbalance results in grid instabilities and, in the worst-case scenario, can lead to a collapse of the power supply in at least one subgrid.

The transmission grid and the subgrids connected to it are therefore conventionally designed for the maximum possible load that can occur in the respective subgrids. This maximum load is taken into account when planning the grid infrastructure, and the various components, such as cables, are designed accordingly. Overcurrent protection devices are installed to prevent damage to the grid infrastructure should the permissible maximum load be exceeded. As soon as the maximum load for which a subgrid is designed is exceeded, the designated overcurrent protection devices automatically disconnect the subgrid in question from the supply grid, thus preventing damage to the grid infrastructure.

From the state of the art, the document US 2014/244060 A1 is known, which describes a system for managing the power supply of a grid of consumers. Each consumer is connected to a local device that is signal-connected to a central device. The consumers are divided into groups with different priorities. Based on these priorities, the central device can initiate a power reduction for the various consumers.

In scenarios with consumers whose electricity consumption is relatively constant and with relatively continuous electricity generation, designing grids and subgrids is relatively simple. However, the increasing use of renewable energy sources and the flexible operation of consumers and storage facilities are making both electricity generation and consumption significantly more volatile. Specifically, solar and wind power plants, for example, only generate sufficient electrical energy when the appropriate environmental conditions prevail. The amount of energy generated can also fluctuate greatly depending on the time of the day. The same applies to consumers, especially electric cars, which represent very large loads on a grid. In addition, both the time and the amount of electrical energy consumed by such consumers are difficult to predict, as they depend on the respective behavior of the users, for example, the vehicle owners. With regard to electromobility, conventional subgrids are not adapted to these new requirements. The high-power peaks caused by volatile generators and consumers can therefore lead to considerable disruptions in the operation of electrical grids. In the worst case, unforeseen power peaks can lead to shutdowns of subgrids due to the grid infrastructure not being designed for these eventualities.

One of the objectives of the invention is therefore to provide a method and a device for preventing a power failure in an electrical grid when unforeseen power peaks occur.

According to the invention, this task is solved by a method with the features specified in claim 1.

The invention thus provides a method for preventing a power failure in at least one electrical subgrid (TN) which is connected to a transmission grid (ÜN) for supplying power to electrical consumers, v, of the subgrid (TN), wherein the electrical consumers, v, of the subgrid (TN) are divided into a number, N, of different groups (G1, G2, . . . Gi . . . GN) of different priorities (p1, p2, . . . pi . . . pN), the method comprising the steps of:
calculating a total required reduction electrical current, Ired-total, by which the total electrical current currently consumed by all consumers, v, of the subgrid (TN), lact-total, is to be reduced in order to avoid a detected overload in the subgrid (TN);
determining a group target electrical current (IsollGi) for each assigned group (Gi) of consumers, v, based on the total required reduction electrical current, Ired-total, and an electrical current that can be saved by the respective group (Gi) (DeltaGi=lactGi-IminGi);
calculating target electrical currents (Isoll-v) for the electrical consumers, v, of the assigned groups (G1, G2, . . . Gi . . . GN) of the subgrid (TN) depending on the determined group target electrical current (IsollGi); and
reducing the amount of electricity currently consumed by the consumers, v, of the respective group (Gi) until the determined group target electrical current (IsollGi) for the respective group (Gi) is reached, wherein, if a group (Gi) of consumers, v, has been marked as a group that can be shut down (Allow to Shutdown), the electricity consumption of a consumer, v, within the marked group (Gi) is reduced to zero if the electricity consumption of the consumer, v, falls below a minimum amount of electrical current consumption ascribed to this consumer, v, Imin-v, and wherein, after calculating the target electrical currents of the electrical consumers, v, for each of the assigned groups of electrical consumers of the subgrid, starting with the group of electrical consumers, v, with the lowest priority and continuing until the group of electrical consumers with the highest priority is reached, the amount of electrical current currently consumed by the electrical consumers, v, of the respective group is mathematically reduced until the group target electrical current calculated for the respective group is reached.

In one possible embodiment of the method, the target electrical currents (Isoll-v) of consumers, v, within an assigned group (Gi) are derived from the group target electrical current (IsollGi) of the respective group.

In one possible embodiment of the method, for the calculation of the target electrical currents (Isoll-v) for the electrical consumers, v, of the assigned groups (G1, G2, . . . Gi . . . GN) of the subgrid (TN), for each of the assigned groups (Gi) of electrical consumers, v, of the subgrid (TN), starting with the group (GN) of electrical consumers with the lowest priority (pN), the following steps are performed:
calculating the savable group electrical current (IsparGi) that can be saved by each assigned group (Gi) as the difference between the currently consumed group electrical current, lactGi, currently consumed by all consumers, v, of the respective group (Gi) and a minimum group electrical current consumption, IminGi of the group (Gi) required to supply power to all consumers of the respective group (Gi); and
calculating a remaining residual electricity consumption for each assigned group (Gi) based on the total required reduction in electricity consumption by subtracting the calculated savable amount of electricity of the respective group (Gi) from the residual amount of electricity calculated for the previous group (Gi+1).

In one possible embodiment of the method, the sub-steps for calculating the target electrical currents (Isoll-v) of the consumers, v, are repeated until the calculated remaining residual electrical current, Iresti, is less than or equal to zero (Iresti <=0) or until the group (G1) of consumers, v, with the highest priority (G1) is reached.

In one possible embodiment of the method, an overload that is about to occur within the subgrid (TN) is automatically detected as soon as the currently consumed total electrical current, lact-total, of all consumers, v, of all groups (G1-GN) of the subgrid (TN) exceeds a predetermined maximum permissible electrical current, Imax-TN, of the subgrid (TN).

In one possible embodiment of the method, the measured currently consumed electrical currents, lact-v, of all consumers, v, of a group (Gi) are added up to the group electrical current (lactGi) of the group (Gi).

In one possible embodiment of the method, the currently consumed group electrical currents (lactGi) of all assigned groups (G1 to GN) of consumers of the subgrid (TN) are added together to calculate the currently consumed total electrical current, lact-total, of the subgrid (TN).

In one possible embodiment of the method, the total required reduction electrical current, Ired-total, by which the total electrical current currently consumed by all consumers, v, of the subgrid (TN), lact-total, must be reduced in order to avoid overload in the subgrid (TN), is calculated as the difference between the currently consumed total electrical current, lact-total, of all consumers, v, of the subgrid (TN) and the specified maximum permissible electrical current, Imax-TN, of the subgrid (TN).

In one possible embodiment of the method, if the calculated remaining residual electrical current, Iresti, after reaching the group (G1) of electrical consumers with the highest priority (p1) is greater than zero (Irest1>0) for each of the assigned groups (Gi) of electrical consumers of the subgrid (TN), starting with the group (GN) of electrical consumers with the lowest priority (pN), the following steps(S) are performed:
marking the respective group (Gi) as a group that can be shut down (Allow to Shut Down); calculating for each consumer, v, of the marked group (Gi) a savable electrical current, Iv, that can be saved by shutting down (Shut Down) the relevant consumer, v; and
reducing the remaining residual electrical current, Iresti, by the savable electrical current, Iv, that can be saved by shutting down the consumer, v;
wherein the above steps are repeated until the calculated remaining residual electrical current, Iresti, is less than or equal to zero (Iresti <=0) or until the group (G1) of consumers, v, with the highest priority (G1) is reached.

In one possible embodiment of the method, following the calculation of the target electrical currents (Isoll-v) of the consumers of the subgrid (TN) for each group (Gi), the currently consumed electrical current, lact-v, of each consumer, v, within the respective group (Gi) is gradually reduced physically by an electrical current reduction (Delta-Iminus) in a round-robin process until the determined target group electrical current (IsollGi) for the group in question (Gi) is reached.

In one possible embodiment of the method, if a group (Gi) of consumers, v, has been marked as a group that can be shut down (Allow to Shut down), the electrical current consumption of a consumer, v, within the marked group (Gi) is reduced to zero as soon as the electrical current consumption of the consumer, v, falls below a minimum electrical current consumption, Imin-V.

In one possible embodiment of the method, if, after the reduction of the electrical current consumption of the consumers, v, of all groups of the subgrid (TN) there is no longer any risk of an overload occurring in the subgrid (TN), the electrical current consumption of the consumers, v, of the subgrid (TN) is increased for each of the assigned groups (Gi) of electrical consumers, v, of the subgrid (TN), starting with the group (G1) of electrical consumers with the highest priority (p1) up to the group (GN) with the lowest priority (pN).

In this process, the current electrical current consumed, lact-v, by each consumer, v, within the respective group (Gi) is increased by an electrical current increase (Delta-Iplus) in one or more increase steps, provided that by doing so no maximum permissible electrical current, Imax-v, for the consumer in question, v is exceeded.

In one possible embodiment of the method, a number, ki, of the increase steps taken to increase the currently consumed electrical current, lact-v, of a consumer, v, within a group (Gi) depends on the priority (pi) of the respective group (Gi) and the number, N, of the assigned groups, G (ki=N−pi).

In one possible embodiment of the method, the consumers, v, of the subgrid (TN) have controllable and/or switchable loads and/or loads that can be connected to charging points of the subgrid (TN).

In one possible embodiment of the method, the consumers, v, of the subgrid (TN) have permanently installed loads, in particular heat pumps or inverters, and connectable loads, in particular vehicle batteries that can be connected to charging points of the subgrid (TN).

In one possible embodiment of the method, a load is dynamically assigned to a group (Gi) when connected to a charging point of the subgrid (TN) depending on at least one provided classification criterion.

In one possible embodiment of the method, the electrical current increase and the electrical current reduction depend on the type of consumer, v.

In one possible embodiment of the method, at least some of the electrical consumers, v, of a subgrid (TN) communicate their respective permitted electrical current increase and/or their permitted electrical current reduction.

The invention also provides an electrical subgrid with the features specified in claim 19.

The invention therefore provides an electrical subgrid, TN, in particular a charging grid, with several electrical consumers, v, and with a control system for implementing a method for preventing a power failure in the subgrid, TN, which is connected to a transmission grid (ÜN) for supplying power to electrical consumers, v, of the subgrid (TN), wherein the electrical consumers, v, of the subgrid (TN) are divided into a number, N, of different groups (G1, G2, . . . Gi . . . GN) of different priorities (p1, p2, . . . pi . . . pN), with the steps:
calculating a total required reduction electrical current, Ired-total, by which the total electrical current currently consumed by all consumers, v, of the subgrid (TN), lact-total, is to be reduced in order to avoid a detected overload in the subgrid (TN);
determining a group target electrical current (IsollGi) for each assigned group (Gi) of consumers, v, based on the total required reduction electrical current, Ired-total, and a savable group electrical current (IsparGi) that can be saved by the respective group (Gi);
calculating target electrical currents (Isoll-v) for the electrical consumers, v, of the assigned groups (G1, G2, . . . Gi . . . GN) of the subgrid (TN) depending on the determined group target electrical current (IsollGi); and
reducing the amount of electricity currently consumed by the consumers, v, of the respective group (Gi) until the determined group target electrical current (Isoll Gi) for the respective group (Gi) is reached,
wherein, if a group (Gi) of consumers, v, has been marked as a group that can be shut down (Allow to Shutdown), the electricity consumption of a consumer, v, within the marked group (Gi) is reduced to zero if the electricity consumption of the consumer, v, falls below a minimum electrical current consumption, Imin-v, ascribed to this consumer, v, and
wherein, after calculating the target electrical currents (Isoll-v) of the consumers (v) for each of the assigned groups (Gi) of electrical consumers (v) of the subgrid (TN), starting with the group (GN) of electrical consumers with the lowest priority (pN) until the group (G1) of electrical consumers with the highest priority is reached (p1), the currently consumed group electrical current (lactGi) currently consumed by the consumers (v) of the respective group (Gi) is mathematically reduced until the group target electrical current (Isoll Gi) calculated for the respective group (Gi) is reached.

Possible embodiments of the method and the grid according to the invention are described in more detail with reference to the figures.

They show:

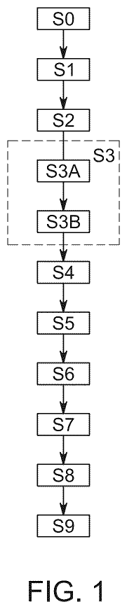

FIG. 1, a flowchart of a possible embodiment of the method according to the invention;

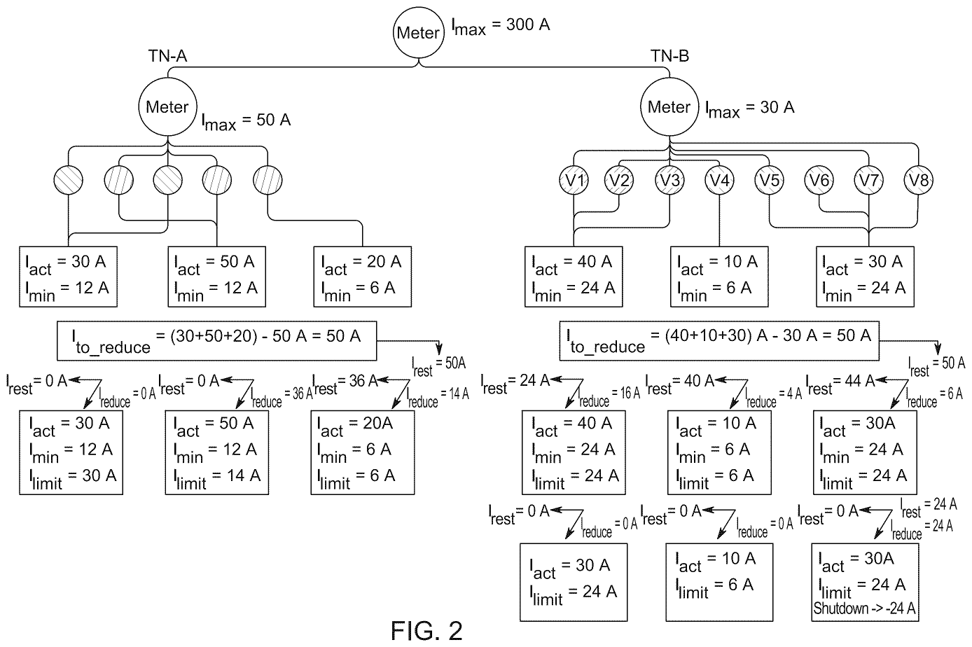

FIG. 2, an example of a grid with two subgrids to explain the method according to the invention;

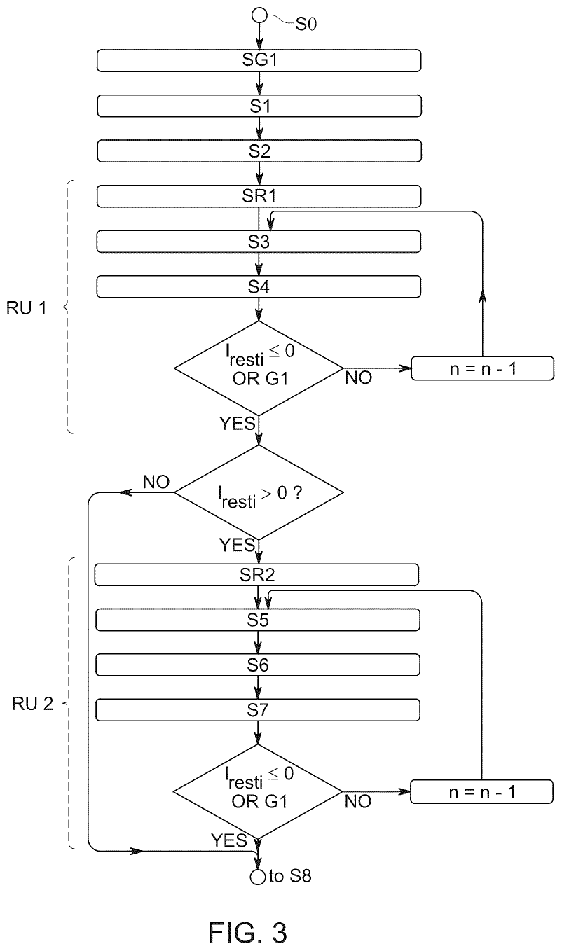

FIG. 3, a flowchart illustrating a possible implementation of steps of the method according to the invention;

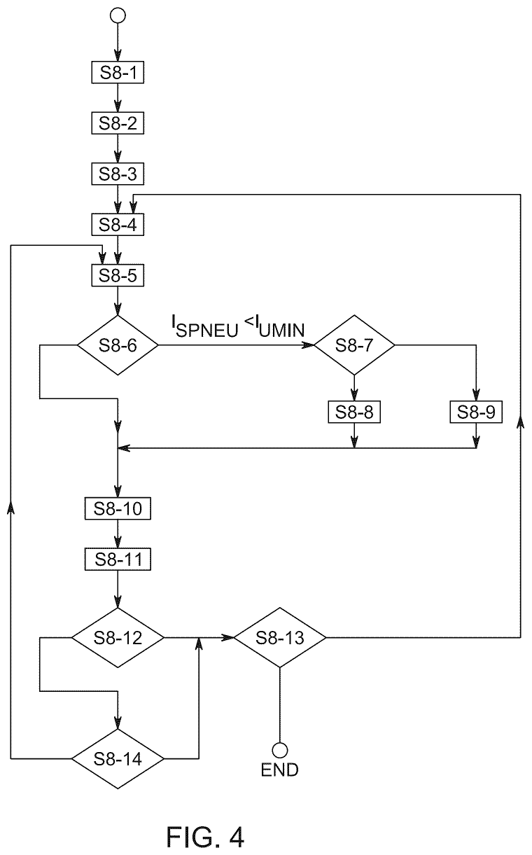

FIG. 4, a flowchart illustrating a possible implementation of further steps of the method according to the invention;

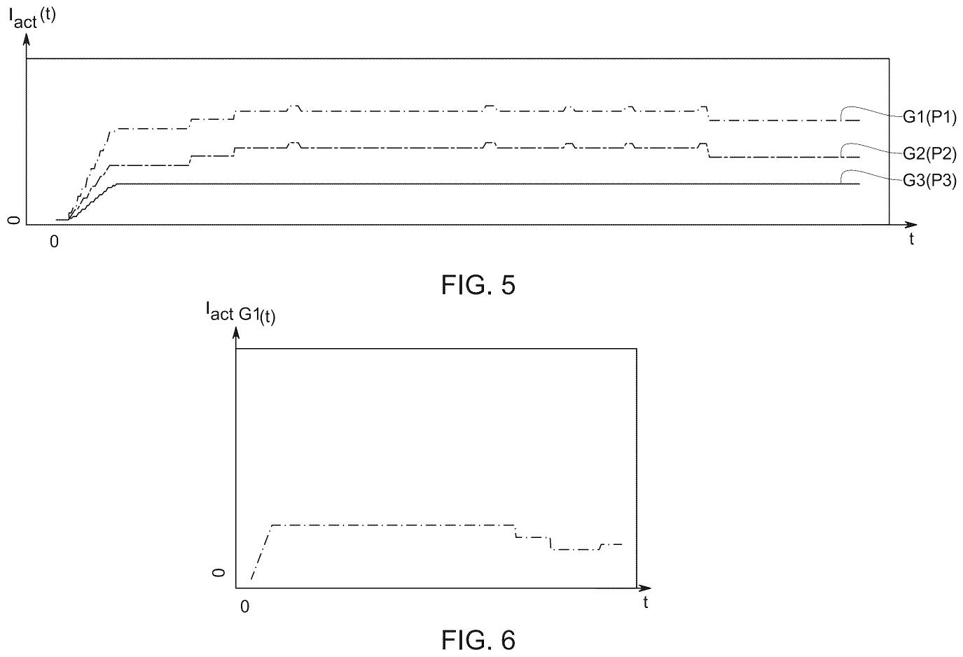

FIGS. 5 to 8, signal diagrams illustrating the method according to the invention.

According to a first aspect, the invention provides a method for preventing a power failure in at least one electrical subgrid (TN). An embodiment of the method is shown schematically as a flowchart in FIG. 1.

A subgrid TN is connected to a transmission grid (ÜN) to supply power to electrical consumers, v, of the subgrid (TN). The subgrid TN can be, for example, a house grid. Furthermore, the subgrid TN can also be a grid of an industrial plant. The consumers v include both DC consumers and AC consumers.

FIG. 2 shows a simple example with two subgrids TN-A and TN-B, each of which is connected to a supply grid via an electricity meter. Each subgrid TN has a maximum permissible electrical current Imax-TN. In the example shown, the first subgrid TN-A has a maximum permissible electrical current Imax-TNA=50 amps and the second subgrid TN-B has a maximum permissible electrical current Imax-TNB=30 amps.

In the example shown in FIG. 2, the subgrid TN-A has five consumers v1A to v5A. In the example shown, the other subgrid TN-B has eight additional consumers v1B to v8B.

The electrical consumers, v, of the respective subgrid TN are first divided into a number, N, of different groups (G1, G2, . . . Gi . . . GN) with different priorities (p1, p2, . . . pi . . . PN). The number N of assigned groups G can vary depending on the application. For example, the first subgrid TN-A and the second subgrid TN-B are each divided into three groups with different priorities, as shown in FIG. 2. In the subgrid TN-A, consumers v1A and v3A form group G1A with the highest priority p1, consumers v2A and v4A form group G2A with the second-highest priority p2, and consumer vA5 forms group G3A with the lowest priority p3. In the subgrid TN-B, consumers v1B, v2B, and v3B form group G1B with the highest priority p1, consumer v4B forms group G2B with the next highest priority p2, and consumers v5B, v6B, v7B, and v8B form group G3B with the lowest priority p3.

The assignment of groups G can be based on a predefined or selectable classification criterion EK. One possible classification criterion EK is the type of consumer v and/or its significance for the operation of a system. Another classification criterion EK is, for example, the operator or user of the respective consumer v. Consumers v or charging points of persons in certain departments within a company, for example, field staff, are given a higher priority p than consumers v or charging points of other persons or users within a company. The expected power consumption of the person can be taken into account. For example, vehicles used by field staff generally require more electrical power than vehicles used by office staff. The classification criterion EK used as a basis and thus the grouping of consumers v can therefore vary over time or dynamically. The classification criterion EK can also be an electricity price per kWh that a user is willing to pay for charging or supplying electricity to their consumer v. The classification criterion EK can also be determined by a logical combination of other classification criteria. Based on the applied classification criterion EK, a priority p is determined for each consumer v.

For each assigned group Gi of consumers v, their currently consumed group electrical current lactGi is calculated and the minimum permissible electrical current consumption IminGi of the group Gi is determined, as shown in the example in FIG. 2. For example, the currently consumed group electrical current lactG1 of group G3B with the lowest priority p3 within subgrid TN-B is 30 amps. The minimum permissible electrical current of this group G1B is, for example, 24 amps.

The currently consumed total electrical current lact-total consumed within a subgrid TN is the sum of the currently consumed electrical currents of all groups G of consumers v within the subgrid TN.

In one possible embodiment of the method, in step S0, an impending overload within the subgrid (TN) is automatically detected as soon as a currently consumed total electrical current, lact-total, of all consumers, v, of all groups (G1-GN) of the subgrid (TN) exceeds a specified maximum permissible electrical current, Imax-TN, of the subgrid (TN) or a predefined threshold value:

$$lact - total > lmax - TN .$$

The total required reduction electrical current, Ired-total, by which the determined or monitored total electrical current consumption, lact-total, of all consumers, v, of the subgrid (TN) must be reduced in order to avoid the impending overload in the subgrid (TN) can be calculated as the difference between the determined total electrical current consumption, lact-total, of all consumers, v, of the subgrid (TN) and a specified maximum permissible electrical current, Imax-TN, of the subgrid (TN):

$$lred - total = lact - total - lmax - TN$$

In the example shown in FIG. 2, the total electrical current consumption lact-total of all consumers v within the subgrid TN-B is:

$$lact - total - TN - B = 40 amps$$

(group G1B) plus 10 amps (group G2B) plus 30 amps (group G3B)=80 amps

In the example shown in FIG. 2, the maximum permissible electrical current Imax-TN-B is 30 amps.

The excess electrical current Ired-total TN-B to be reduced within the TN-B subgrid is therefore 80 amps (lact-total-TN-B) minus 30 amps (Imax-TN-B):

$$lred - total - TN - B = 80 amps - 30 amps = 50 amps$$

The total electrical current consumption lact-total of a subgrid TN can be continuously monitored, for example by periodically measuring the electrical current consumption of all consumers, v, of the subgrid TN and then aggregating the measured consumer electrical currents I of the subgrid TN to the total electrical current consumption, lact-total, of the subgrid TN. The maximum permissible electrical current Imax-TN of a subgrid TN is specified and depends on the interconnected components, in particular the power lines and overcurrent protection devices connected there.

The total amount of electrical current currently or momentarily consumed, lact-total, by all consumers v of the subgrid TN is preferably determined by summing the measured or reported consumption electrical currents of all consumers, v, of the subgrid TN.

In a possible implementation, the currently consumed electrical current, lact-v, of all consumers, v, of a group (Gi) measured by measuring units and reported to the control unit of the subgrid TN are first added up to the currently consumed group electrical current (lactGi) of the group (Gi) in question. Subsequently, the currently consumed group electrical current (lactGi) of all assigned groups (G1 to GN) of consumers of the subgrid (TN) can in turn be added together to calculate the currently consumed total electrical current, lact-total, of the entire subgrid (TN). This total amount of electrical current currently consumed, lact-total, by the subgrid TN is preferably monitored continuously in step S0 in order to detect an impending overload in the subgrid TN. The division of consumers into groups Gi, according to a predetermined or selectable division criterion EK, takes place in step SGi.

In order to avoid an impending power failure in the affected subgrid TN, a calculation of the total required reduction of electrical current consumption, Ired-total, is first performed in a first step S1 of the method according to the invention. This total required reduction electrical current, Ired-total, is the amount of electrical current by which the total amount of electrical current currently consumed by all consumers, v, in the subgrid (TN), lact-total, must be reduced in order to avoid the impending overload in the affected subgrid (TN) detected in step S0.

Subsequently, in step S2 of the method according to the invention, a group target electrical current (IsolIGi) is determined for each of the assigned groups (Gi) of consumers, v, based on the total required reduction electrical current, Ired-total, calculated in step S1 and on the basis of the savable group electrical current (IsparGi) that can be saved by each of the groups (Gi).

In step SR1, the first round (RU1) starts, beginning with the group (GN) with the lowest priority (pN).

In a further step S3 of the method according to the invention, target electrical currents (Isoll-v) are calculated for the different electrical consumers, v, of the various assigned groups (G1, G2, . . . Gi, . . . GN) of the subgrid (TN) as a function of the group target electrical current (IsollGi) determined in step S2 for each of the groups Gi. The target electrical currents (Isoll-v) of consumers, v, within an assigned group (Gi) can be derived from the group target electrical current (IsollGi) of the respective group (Gi) determined in step S2.

In one possible embodiment of the method, in order to perform the computation of the target electrical currents (Isoll-v) for the electrical consumers, v, of the assigned groups (G1, G2, . . . Gi . . . GN) of the subgrid (TN), in step S3, for each of the assigned groups (Gi) of electrical consumers, v, of the subgrid (TN), starting with the group (GN) of electrical consumers with the lowest priority (pN), the following two sub-steps S3A, S3B are performed.

In a first sub-step S3A, the savable group electrical current (IsparGi) that can be saved by each assigned group (Gi) of consumers, v, is calculated as the difference between a group electrical current currently consumed by all consumers, v, of the respective group (Gi), lactGi, of the group (Gi) and a minimum group electrical current consumption IminGi of the group (Gi) required to supply power to all consumers, v, of the respective group (Gi):

$$lsparGi = lactGi - lminGi$$

For example, group G3B with the lowest priority p3 within the subgrid TN-B comprises consumers v5B to v8B. These have a minimum group electrical current consumption IminG3B of 24 amps in total. In contrast, the currently consumed electrical current of group G3B lactG3B is 30 amps.

Thus, the savable group electrical current IsparG3B of group G3B with the lowest priority p3 within the subgrid TN-B is:

$$lsparG 3 B = lactG 3 B - lminG 3 B = 30 amps - 24 amps = 6 amps$$

In a second sub-step S3B, for each assigned group (Gi), based on the total required reduction electrical current calculated in step S1, (Ired−total=IrestN+1), a remaining residual electrical current Iresti is calculated by subtracting the savable group electrical current (IsparGi) of the respective group (Gi) calculated in step S3A from the residual electrical current (Irest i+1) calculated for the previous group (Gi+1).

$$lrest i = lrest i + 1 - lsparGi$$

In the example shown in FIG. 2, the total required reduction electrical current (Ired-total=lirest0) for the subgrid TN-B is 50 amps. From this, the savable group electrical current IsparG3B=6 amps of the group G3B with the lowest priority p3 is subtracted to calculate a residual electrical current Irest0.

The calculated remaining residual electrical current Irest1 is therefore 50 amps minus 6 amps, equal to 44 amps.

$$lrest 1 = lrest 0 ( = 50 amps ) - lpsarG 3 B ( = 6 amps ) = 44 amps$$

In one possible embodiment of the method, the sub-step S3A in the first round (RU1) for calculating the target electrical currents (Isoll-v) of the consumers, v, is repeated in a first round (RU 1) until the calculated remaining residual electrical current, Iresti, becomes less than or equal to zero (Iresti <=0) or until the group (G1) of consumers, v, with the highest priority (G1) has been taken into account.

In the example shown in FIG. 2, the residual electrical current Irest3 calculated for the subgrid TN-B after taking into account the group G1B with the highest priority p1 is still 24 amps, i.e., the calculated reduction of the electrical current consumed in the first round (RU 1) is not yet sufficient. Therefore, in further steps, it is preferable to check whether the remaining electrical current reduction of 24 amps can be achieved by shedding consumers v of the subgrid TN-B in a second round (RU 2).

In the example shown in FIG. 2, the residual electrical current Irest2 calculated for the other subgrid TN-A after taking into account group G2A with the second-highest priority p2 is already zero amps after the first round, i.e., the calculated achievable electrical current reduction is already sufficient after the first round (RU 1), and a shedding of consumers v in the subgrid TN-A can be avoided.

In step S4 of the method according to the invention, the electrical current currently consumed by the consumers v of the respective group (Gi) is reduced until the group target electrical current (Isoll Gi) determined for the respective group (Gi) in step S2 is reached. The reduction of the electrical current in step S4 can initially be performed mathematically, i.e., not yet physically.

After the calculation of the target electrical currents (Isoll-v) of the consumers v for each of the assigned groups (Gi) of electrical consumers, v, of the subgrid (TN) in the two sub-steps S3A, S3B of step S3, in step S4, beginning with the group (GN) of electrical consumers, v, with the lowest priority (pN) up to the group (G1) of electrical consumers v with the highest priority (p1), the currently consumed group electrical current lactGi currently consumed by the consumers v of the respective group (Gi) is reduced mathematically until the group target electrical current Isoll Gi calculated for the respective group (Gi) in step S2 is reached.

In one possible embodiment of the method, if the calculated remaining residual electrical current, Iresti, is still greater than zero (Irest>0) after taking into account the group (G1) of electrical consumers with the highest priority (p1), for example 24 amps for subgrid TN-B in FIG. 2, for each of the assigned groups (Gi) of electrical consumers of the subgrid (TN), starting with the group (GN=G3B) of electrical consumers v with the lowest priority (pN=p3), the following further steps (S5, S6, S7) are performed, wherein step SR2 initiates the start of the second round (RU 2), beginning with group (GN) with the lowest priority (pN):
marking in step S5 the respective group (Gi) as a group that can be shut down (Allow to Shut Down);
calculating, in step S6, for each consumer, v, of the marked group (Gi) a savable electrical current, Ispar, that can be saved by shutting down (ShutDown) the consumer, v in question; and
reducing (mathematically), In step S7, the remaining residual electrical current, Iresti, by the savable electrical current, Ispar-v, that can be saved by switching off the consumer, v.

For example, by mathematically shutting down consumers v5B to v8B of group G3B with the lowest priority p3 within the subgrid TN-B in round 2, a remaining residual electrical current of zero amps is achieved, as shown in FIG. 2.

The above steps S5, S6, S7 of the second round (RU 2) are repeated until the calculated remaining residual electrical current, Iresti, is less than or equal to zero (Iresti <=0) or the group (G1) of consumers, v, with the highest priority (p1) has been taken into account.

FIG. 3 shows a flowchart of a possible implementation of steps S1 to S7 with the two calculation rounds (RU1, RU 2) for calculating the set electrical currents or target electrical currents Isoll-v for the consumers v of a subgrid TN.

In one possible embodiment of the method, following the calculation of the target electrical currents Isoll-v of the consumers v of the subgrid (TN) in steps S1 to S7, in a further step S8, the currently consumed electrical current, lact-v, currently consumed by or supplied to each consumer, v, within the respective group (Gi) is gradually reduced in a round-robin process by an electrical current reduction (Delta-Iminus) until the group target electrical current (IsollGi) determined for the group (Gi) in question is reached, as shown in FIG. 4.

FIG. 4 shows a flowchart of a possible implementation of the physical setting of the consumers v of a subgrid TN in step S8 according to the target electrical currents Isoll-v of the consumers v of the subgrid TN calculated in the flowchart according to FIG. 3. After dividing the consumers v into groups Gi in step S8-1, in step S8-2 it will be started with the group GN with the lowest priority PN. To do this, the consumer electrical current setpoint group is first initialized in step S8-3 and started in step S8-4 with any consumer v in the group G. In step S8-5, a new setpoint ISP-neu is calculated for the consumer v. Then, in step S8-6, a check is made to see whether the new setpoint ISP-neu calculated in step S8-5 is lower than the permissible minimum electrical current IUmin of the consumer v. If this is the case, a further check is made in step S8-7 to see whether the group G is marked as disconnectable or not. If group G is marked as non-disconnectable, the new setpoint ISP-neu is set to the minimum electrical current IUmin in step S8-8 (ISP-neu:=IUmin). If, on the other hand, the group G is marked as disconnectable, the new setpoint ISP-neu is set to zero in step S8-9 (ISPneu:=0). The sum of the reduced electrical current in the group G is then determined in step S8-10. In step S8-11, the new setpoint ISP-neu is sent to the consumer v in question for a physical adjustment.

In the next step S8-12, a check is made to see whether the reduced electrical current is greater than the electrical current to be reduced (IsollGi). If this is the case, in step S8-13 it is checked whether there are any other groups G in the subgrid TN. If there are other groups, the loop returns to step S8-4, as shown in FIG. 4. However, if there are no other groups G, the process ends. If the check in step S8-12 shows that the reduced electrical current is not greater than the electrical current to be reduced (IsollGi), in step S8-14 it is checked whether there are any other consumers v in the group G in question. If there are no further consumers v in group G, the method proceeds to step S8-13. However, if there are further consumers v in group G, it will be returned to step S8-5 in a loop, as shown in FIG. 4. This is repeated until the electrical current to be reduced for this group G (IsollGi) is reached.

In one possible embodiment of the method, if a group (Gi) of consumers, v, has been marked as a group that can be shut down (Allow to Shutdown) in step S5, the electrical current consumption ISP-neu of a consumer, v, within the marked group (Gi) is reduced to zero (ISPneu=0) as soon as the electrical current consumption of the consumer, v, falls below a minimum electrical current consumption, Imin-v, ascribed to this consumer, v (ISPneu<IUmin).

In a possible embodiment of the method, if, after the physical reduction of the electrical current consumption of the consumers, v, of all groups G of the subgrid (TN) in step S8, there is no longer any risk of an overload occurring in the subgrid (TN), the electrical current consumption of the consumers, v, of the subgrid (TN) is increased again in step S9 for each of the assigned groups (Gi) of electrical consumers, v, of the subgrid (TN), starting with the group (G1) of electrical consumers v with the highest priority (p1) and ending with the group (GN) with the lowest priority (pN).

To this end, in step S9, the currently consumed electrical current, lact-v, of each consumer, v, within the respective group (Gi) is increased by an electrical current increase (Delta-Iplus) in one or more increase steps, provided that this does not exceed the maximum permissible electrical current, Imax-v, for the consumer, v, in question.

The number, ki, of increase steps taken to increase the currently consumed electrical current, lact-v, of a consumer, v, within a group (Gi) in step S9 depends on the priority (pi) of the respective group (Gi) and the number, N, of assigned groups, G: ki=N−pi

In one possible embodiment of the method, the consumers, v, of the subgrid (TN) have controllable and/or disconnectable loads. The consumers, v, of the subgrid (TN) can have permanently installed loads, in particular heat pumps or inverters, and connectable loads, in particular vehicle batteries that can be connected to charging points of the subgrid (TN).

In one possible embodiment, the subgrid TN is a charging grid with charging points or charging stations for charging connectable electric vehicles as consumers v. This subgrid TN can, for example, be provided at a company parking lot for charging employees' vehicles. The electric vehicles generally do not have wireless communication capabilities with the control system of the subgrid TN. The electric vehicles normally communicate exclusively via a charging cable with the charging station (wallbox). This charging station has a wired and/or wireless communication interface with the control system of the subgrid TN. In an alternative implementation, the electric vehicles each have their own control unit that can communicate directly with the control system of the subgrid TN via a wireless interface. For example, the control unit of the electric vehicle reports the current state of charge (SoC) of its vehicle battery directly or indirectly via the charging station to the control system of the subgrid TN. One possible classification criterion EK for classifying the consumers or vehicle batteries to be charged is the state of charge SoC For example, an electric vehicle battery belonging to a high-ranking employee (EK1) of the company is given a high priority p if the state of charge SoC of the electric vehicle battery is below a defined threshold value (EK2).

The priority p for charging a consumer v can therefore change over time. The grouping of consumers v can, for example, be renewed periodically. If a consumer v is assigned to a group G with a lower priority p, e.g., during the charging process, the charging process may prolong itself. The additional charging time required is preferably communicated to the user of the affected electric vehicle by the control system of the subgrid TN via the wireless interface, for example on a display in the vehicle or on a display on the user's mobile phone.

In one possible embodiment of the method, a load is dynamically assigned to a group (Gi) when connected to a charging point of the subgrid (TN) depending on at least one provided assignment criterion.

In one possible embodiment of the method, the electrical current increase (Delta-Iplus) used in step S9 and the electrical current reduction (Delta-Iminus) used in step S8 depend on the type of consumer, v. At least some of the electrical consumers, v, of a subgrid (TN) can each report or communicate their associated permitted electrical current increase (Delta-Iplus) and/or their permitted electrical current reduction (Delta-Iminus) to the control system of the subgrid TN or to a server, for example via a wireless interface.

The method according to the invention can be executed on a processor of a local controller or a local control unit of a subgrid TN. Alternatively, the method can also be executed on a server in a cloud. The method is preferably executed in real time.

According to a further aspect, the invention creates an electrical subgrid, TN, with several electrical consumers, v, and with a control system for implementing a method for preventing a power failure in the subgrid TN. The subgrid TN is provided to supply power to or charge several electrical consumers, v. The subgrid TN is connected to a transmission grid (ÜN), for example to a public power supply grid, at a transfer point. Several subgrids TN can be connected to a common transmission grid ÜN.

The various electrical consumers, v, of the subgrid (TN) are divided into a number, N, of different groups (G1, G2, . . . Gi, . . . GN) with different priorities (p1, p2, . . . pi, . . . pN). The division can be done automatically or manually.

The local control system of the subgrid TN can have several calculation units.

A first calculation unit of the control unit is provided for calculating a total required reduction electrical current, Ired-total, by which the total electrical current currently consumed by all consumers, v, of the subgrid (TN), lact-total, is to be reduced in order to avoid a detected overload in the subgrid (TN).

A second calculation unit of the control unit is provided for determining a group target electrical current (IsolIGi) for each assigned group (Gi) of consumers, v, based on the total required reduction electrical current, Ired-total, and an electrical current that can be saved by the respective group (Gi).

A third calculation unit of the control unit is provided for calculating target electrical currents (Isoll-v) for the electrical consumers, v, of the assigned groups (G1, G2, . . . Gi, . . . GN) of the subgrid (TN) as a function of the determined group target electrical current (IsollGi).

A fourth calculation unit of the control unit is provided for reducing the electrical current currently consumed by the consumers, v, of the respective group (Gi). The reduction can be calculated until the group target electrical current (IsollGi) determined for the respective group (Gi) is reached.

The various calculation units are preferably integrated or implemented in a processor of the control system or in a server.

The method can be implemented as a program or application. The grouping of consumers v in the subgrid TN can be carried out automatically or semi-automatically or interactively by a user or operator of the subgrid TN, for example with the aid of a user interface GUI on a computer in the subgrid TN. Selectable classification criteria EK can also be displayed to the user. The assigned groups Gi with their consumers v and associated persons or drivers as well as electrical current parameters (e.g., SoC) can also be displayed to the user or operator of the subgrid TN in real time, for example schematically as shown in FIG. 2.

The method according to the invention and the corresponding control device thus intelligently prevent unwanted shutdowns or blackouts of subgrids TN by actively influencing the electrical current consumption of controllable loads and consumers v of the subgrid TN. The method makes it possible to regulate the electrical current consumption of consumers v in such a way that there is no overload in a defined subgrid TN and thus no unwanted shutdown (blackouts) of a subgrid TN. The method allows the characteristics of the respective consumers/generators v of the subgrid TN to be taken into account. For example, it can be taken into account that arbitrarily small electrical currents cannot be regulated or that certain consumers v require a minimum electrical current in order to function properly. Furthermore, the method according to the invention allows the regulation of consumers v to be prioritized so that, in a typical application, consumers v of certain departments (e.g., vehicle batteries of a company's office staff) are limited in their electrical current consumption first. The method also takes into account a worst-case scenario, namely the occurrence of a large overload of the subgrid TN. In this case, the method can be used to specifically shed (i.e., completely switch off) certain loads or consumers v. This means that these loads or consumers v are disconnected from the subgrid TN, but the stability of the rest of the grid is ensured, thus preventing a total failure of the subgrid TN. The method also includes the process of gradually increasing the electrical current of the controllable loads or consumers v after the overload has decreased or been prevented until the previously limited or shed loads are reached.

The method essentially comprises two main functions, namely an increase function on the one hand and a reduction function on the other.

In the event of an impending overload of the supply subgrid TN detected in step S0, the “reduction” function of the method calculates new target electrical currents Ivsoll for the controllable loads or controllable consumers v in steps S1-S7 and then reduces the electrical currents of these controllable loads or consumers to these calculated target electrical currents Ivsoll.

If there is no longer an overload in the subgrid TN, the “increase” function becomes active and begins to increase the electrical current of the consumers v again in step S9. For this purpose, increase rounds can be calculated for each group Gi, with the group Gi with the highest priority p receiving the most increase rounds. The number ki of increase rounds for a group Gi with a priority pi depends preferably on the cardinality N of the assigned groups G (ki=N−pi). The group GN with the lowest priority pN has exactly one increase round.

It will be started with the group G1 with the highest priority p1. The current increase step is 1 amp, for example. For consumers v that have been switched off, this current increase step corresponds to the stored hysteresis electrical current. If the electrical current lactv of the consumer v plus the increase electrical current does not exceed the maximum permissible electrical current Imax-v of the consumer v, in this step the electrical current of the consumer v is increased by the increase electrical current. This is repeated with all consumers v within a group G. The number of increase rounds within a group G is defined by the priority p of the respective group G. Then it will be continued with the next group G in the same way.

This increase algorithm ensures that each consumer v, regardless of the priority p, receives at least the hysteresis electrical current or the minimum electrical current, provided that the current situation in the grid infrastructure allows this.

FIGS. 5 to 8 show diagrams explaining how the method according to the invention works.

FIG. 5 shows the currently consumed electrical currents lact for three different groups G1, G2, G3 with different priorities p1, p2, p3. The currently consumed electrical current lactG1 of group G1 of consumers v with the highest priority p1 is greater than the currently consumed electrical current lactG2 of group G2 of consumers v with the second-highest priority p2, which in turn is greater than the currently consumed electrical current lactG3 of group G3 of consumers v with the lowest priority p3. (lactG1>lactG2>lactG3)

FIG. 6 shows a simulation of the current electrical current consumption of the group G1 of consumers v with the highest priority p1.

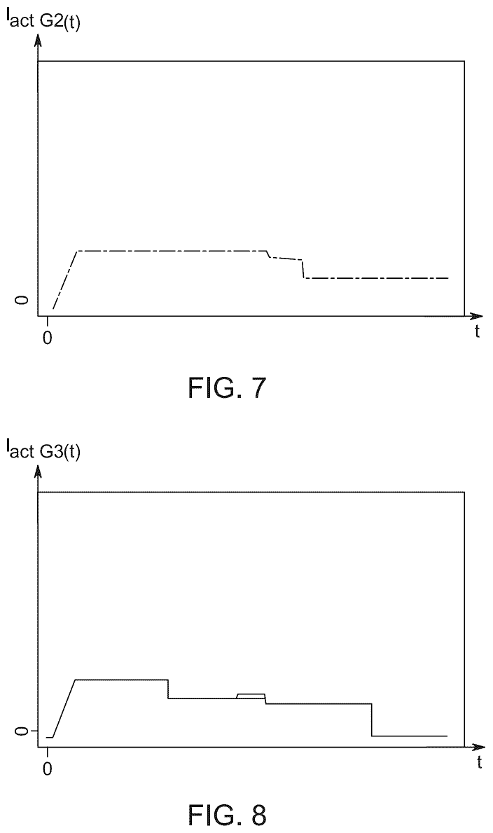

FIG. 7 shows a simulation of the current electrical current consumption of the group G2 of consumers v with the second-highest priority p2.

FIG. 8 shows a simulation of the current electrical current consumption of the group G1 of consumers v with the lowest priority p3.

As can be seen in FIGS. 6 to 8, if necessary, the electrical current consumption of the consumers v in group G1 with the highest priority p1 is reduced or shut down last in comparison to the electrical current consumption of the two remaining groups G2 and G3. As can be seen in FIG. 8, in the example shown, the entire group G3 of consumers v with the lowest priority p3 is shut down at a certain point in time.

The signal diagrams according to FIGS. 5-8 are displayed to a user in a possible implementation via a graphical user interface of a computer of the subgrid TN or via a graphical user interface of a remote control center connected to it via a data grid.

The computer-implemented method according to the invention is suitable for a large number of applications. For example, the method can run in the background in a charging grid of a company parking lot. Another application is, for example, in the field of logistics, charging a fleet of electrically powered forklifts or other transport vehicles as consumers v. The consumers v can also include household appliances in a home grid or machines in an automation system. It can also be a mixture of these devices/loads, for example. In a manufacturing company, for instance, there may be a heterogeneous composition of these loads or consumers v, in particular company cars, logistics fleets, machines, systems, etc.

1. A method for preventing a power failure in at least one electrical subgrid which is connected to a transmission grid for supplying power to electrical consumers of the subgrid, wherein the electrical consumers of the subgrid are divided into a number of different groups of different priorities, the method comprising the steps of:
calculating a total required reduction electrical current, by which the currently consumed total electrical current of all consumers of the subgrid is to be reduced in order to avoid a detected overload in the subgrid;
determining a group target electrical current for each assigned group of consumers based on the total required reduction electrical current and a savable group electrical current that can be saved by the respective group;
calculating target electrical currents for the electrical consumers of the assigned groups of the subgrid depending on the determined group target electrical current; and
reducing the amount of electricity currently consumed by the consumers of the respective group until the determined group target electrical current for the respective group is reached,
wherein, if a group of consumers, v, has been marked as a group that can be shut down (Allow to Shutdown), the electricity consumption of a consumer within the marked group is reduced to zero if the electricity consumption of the consumer falls below a minimum electrical current consumption ascribed to this consumer and
wherein, after calculating the target electrical currents of the electrical consumers for each of the assigned groups of electrical consumers of the subgrid, starting with the group of electrical consumers with the lowest priority until the group of electrical consumers with the highest priority is reached, the currently consumed group electrical current by the electrical consumers of the respective group is mathematically reduced until the group target electrical current calculated for the respective group is reached.

2. The method according to claim 1,
wherein the target electrical currents of consumers within an assigned group are derived from the group target electrical current of the respective group.

3. The method according to claim 2,
wherein, for the calculation of the target electrical currents for the electrical consumers of the assigned groups of the subgrid, the following steps are performed for each of the assigned groups of electrical consumers of the subgrid, starting with the group of electrical consumers with the lowest priority:
calculating the amount of electricity that can be saved by each assigned group as the difference between the currently consumed group electrical current of the group currently consumed by all consumers of the respective group and the minimum group electrical current consumption of the group required to supply power to all consumers of the respective group;
calculating for each assigned group, based on the total required reduction electrical current, a remaining residual electrical current by subtracting the calculated savable amount of electricity of the respective group from the residual amount of electricity calculated for the previous group.

4. The method according to claim 3,
wherein the sub-steps for calculating the target electrical currents of the consumers are repeated until the calculated remaining residual electrical current is less than or equal to zero or until the group of consumers with the highest priority is reached.

5. (canceled)

6. The method according to claim 1,
wherein an overload that is about to occur within the subgrid is automatically detected as soon as a currently consumed total electrical current of all consumers of all groups of the subgrid exceeds a predetermined maximum permissible electrical current of the subgrid.

7. The method according to claim 1,
wherein measured or reported currently consumed electrical currents of all consumers of an assigned group are added up to a currently consumed group electrical currents of the group, and
wherein the currently consumed group electrical currents of all assigned of consumers of the subgrid are added together to calculate the currently consumed total electrical current of the subgrid.

8. The method according to claim 7,
wherein the total required reduction electrical current by which the currently consumed total electrical current of all consumers of the subgrid to avoid an overload is to be reduced is calculated as the difference between the currently consumed total electrical current of all consumers of the subgrid and the specified maximum permissible electrical current of the subgrid.

9. The method according to claim 3,
wherein, if the calculated remaining residual electrical current after reaching the group of electrical consumers with the highest priority is greater than zero (Irest1>0) for each of the assigned groups of electrical consumers of the subgrid, starting with the group of electrical consumers with the lowest priority, the following steps are performed:
marking the respective group as a group that can be shut down (Allow to Shut Down);
calculating for each consumer of the marked group a savable electrical current that can be saved by shutting down the relevant consumer;
reducing the remaining residual electrical current computationally by the savable electrical current that can be saved by shutting down the consumer;
repeating the above steps long as the calculated remaining residual electrical current is greater than zero (Iresti >0) or until the group of consumers with the highest priority has been taken into account.

10. The method according to claim 9,
wherein, following the calculation of the target electrical currents of the consumers of the subgrid for each group, the currently consumed electrical current of each consumer within the respective group is physically reduced step by step in a round-robin process by an electrical current reduction until the determined group target electrical current for the group in question is reached.

11. (canceled)

12. The method according to claim 1,
wherein, if after the reduction of the electrical current consumption of the consumers of all groups of the subgrid there is no longer any risk of an overload occurring in the subgrid, for each of the assigned groups of electrical consumers of the subgrid, the electrical current consumption of the consumers is increased, starting with the group of electrical consumers with the highest priority up to the group with the lowest priority, such that the currently consumed electrical current of each consumer within the respective group is increased by an electrical current increase in one or more increase steps, as long as this does not exceed a maximum permissible electrical current of the consumer in question.

13. The method according to claim 12,
wherein a number of the increase steps performed to increase the currently consumed electrical current of a consumer within a group depends on the priority of the respective group and the number of the assigned groups (ki=N−pi).

14. The method according to claim 1,
wherein the consumers of the subgrid have controllable and/or switchable loads and/or loads that can be connected to charging points of the subgrid.

15. The method according to claim 14,
wherein the consumers of the subgrid comprise permanently installed loads, in particular heat pumps or inverters, and connectable loads, in particular vehicle batteries of electric vehicles connectable at charging points of the subgrid.

16. The method according to claim 15,
wherein a load is dynamically assigned to a group when connected to a charging point of the subgrid depending on at least one provided classification criterion.

17. The method according to claim 12,
wherein the electrical current increase and the electrical current reduction depend on a type of consumer.

18. The method according to claim 17,
wherein at least some of the electrical consumers of a subgrid each communicate their associated permitted electrical current increase and/or their permitted electrical current reduction to a control system of the subgrid.

19. An electrical subgrid, in particular a charging grid, with several electrical consumers and with a control system for implementing a method for preventing a power failure in the subgrid according to claim 1.
